(19) United States
(12) Patent Application Publication
(10) Pub. No.: US 2002/0188504 A1
(43) Pub. Date: Dec. 12, 2002

(54) Monitoring usage of printer consumables to initiate promotional actions

(76) Inventor: Margo N. Whale, Kuna, ID (US)

Correspondence Address: HEWLETT-PACKARD COMPANY, Intellectual Property Administration, P. O. Box 272400, Fort Collins, CO, 80527-2400, US

(21) Appl. No.: 09/876,450

(22) Filed: Jun. 7, 2001

(51) Int. Cl. G06F 17/60; G06F 11/00; G06F 15/00

(52) U.S. Cl. 705/14; 702/188

(57) ABSTRACT

A print system communicates with a vendor system to order components. During data sessions in which orders are placed and received, the vendor system gathers usage parameters indicating levels of consumable product usage by print devices. The vendor system monitors the usage parameters over time and detects changes in usage levels by different print systems. If consumable product usage has changed by a predetermined amount, the vendor system initiates promotional activities directed to operators of the print systems.

### TECHNICAL FIELD

This invention relates generally to marketing consumable products used in printing devices and, more particularly, to determining appropriate times to make special promotional offers to consumable product customers.

### BACKGROUND

Printing devices utilize a number of different types of replaceable and/or consumable items. These items include print media, marking agents and rotating components that deteriorate over time as a result of wear and tear. Consumable print media include paper of varying weights and different types of high-value media such as transparencies and glossy photo paper. Consumable marking agents include ink, wax, powder toner, thermal agents, and the like, that are typically housed in some type of cartridge such as a toner cartridge.

For example, a toner cartridge is installed in a laser printer to provide toner for the printing process. As documents are printed, the toner supply is gradually depleted. When the toner supply is completely exhausted, the printer cannot print any further documents until the toner cartridge is replaced. An owner of the printer must now look to purchase a replacement toner cartridge for the printer.

There are multitudes of manufacturers and vendors of toner cartridges that vie for the opportunity to sell replacement toner cartridges to those printer owners having such a need. Because it is vitally important to reach these potential customers, virtually every marketing avenue has been exploited to contact printer owners and induce them to purchase the vendor's replacement toner cartridges.

One way to persuade printer owners to purchase particular replacement toner cartridges (and other replacement consumables) is to provide a financial incentive. For example, a vendor may offer an incentive whereby a printer customer may purchase a toner cartridge for half of the regular price after the customer has already purchased three other toner cartridges. Similarly, the vendor may offer quantity discounts for those of its customers who purchase the highest numbers of products. Incentives other than quantity discounts may also be offered.

In addition, a consumables vendor may offer an incentive to potential customers that benefit the vendor by helping to reduce costs incurred by the vendor. For example, a vendor may be able to save money by handling transactions via the Internet rather than by more conventional printed means because the vendor can save on printing materials, postage, etc. In this instance, the vendor may offer some sort of incentive to potential customers to purchase replaceable printer components via the Internet, e.g. faster delivery, lower cost, valuable coupons for future purchases, rebates, etc.

Incentive marketing programs like those described above are typically marketed to a large number of printer owners. However, it is recognized that the effectiveness of marketing efforts can sometimes be increased by offering incentives at the most opportune times, for example at times when customers are making decisions regarding purchase options. If a vendor is able to anticipate these times and to contact the customer in a timely manner, it is much easier to secure the customer's continued business. Nevertheless, it is difficult to anticipate or predict the times at which a customer might be most receptive to promotional activities. The invention described below addresses this difficulty.

### SUMMARY

In a system in which customers order consumable supplies from a vendor online, usage parameters are gathered during online data sessions. Such usage parameters indicate rates of usage of consumable products such as paper, marking agents, cartridges, etc. The usage parameters are stored and analyzed over time to discern patterns in the customers' usages of these products, and to detect changes in usage. When such changes are detected, the vendor responds by initiating promotional actions. For example, the vendor might respond to an increase in usage by offering a volume discount to the customer.

### BRIEF DESCRIPTION OF THE DRAWINGS

FIG. 1 is a block diagram showing communications between a print system and a vendor system.

FIGS. 2 and 3 are block diagrams illustrating embodiments of print systems.

FIG. 4 is a block diagram showing pertinent components of a printer.

FIG. 5 is a block diagram showing pertinent components of a host computer.

FIG. 6 is a block diagram showing pertinent components of a network server.

FIG. 7 illustrates a graphical usage chart as described herein.

### DETAILED DESCRIPTION

The following description sets forth one or more specific implementations and/or embodiments of systems and methods for marketing printing device replaceable components based on customer printing device usage. The systems and methods incorporate elements recited in the appended claims. These implementations are described with specificity in order to meet statutory written description, enablement, and best-mode requirements. However, Applicant intends these exemplary implementations to be examples only. Applicant does not intend these exemplary implementations to limit the scope of the claims.

Component Configuration

The description will initially focus on typical components that might be used in conjunction with the invention, as well as on the interconnections or interrelationships between such components. Operational characteristics of the system will be described in a subsequent section.

FIG. 1 shows a network system 100 that includes a consumer or customer print system 101 and a vendor system 102. The print system and vendor system are configured for bi-directional communications over a communications medium 104. In this example, the communications medium comprises a public network such as the Internet.

Generally, customer print system 101 comprises a system that includes a printer or printer-like device. Other than printers, printer-like devices might include devices such as copiers and fax machines. For purposes of discussion, such devices will be referred to below simply as printers.

As described above, printers typically utilize consumable products. Such consumable products might include toners, inks, ribbons, paper, and other items. For purposes of discussion, the invention will be illustrated with reference to a printer whose primary consumable product comprises a toner cartridge and the toner contained within the toner cartridge.

Typically, some sort of user interface is provided within print system 101 that allows a printer operator to determine remaining levels of toner within an installed cartridge. Such a user interface might be provided as part of the printer itself. Alternatively, an associated host computer might have printer management software that provides such a user interface.

In addition to allowing an operator to determine current levels of consumable products such as toner, the user interface preferably allows the operator to order additional products from vendor system 102. In current products, this capability is provided through communications with vendor system 102 over a public network such as the Internet. The Internet, in conjunction with modern “browsing” technology, allows a vendor to present a graphical user interface to a remote system such as might be present within print system 101. Using this type of interface, a print device operator is able to specify and order desired components or products from the vendor, through vendor system 102.

Depending on the sophistication of software within print system 101, it is possible for print management components to automatically warn an operator when consumable products such as toner are nearly depleted. Furthermore, the print management components can automatically initiate a data session with vendor system 102 for the purpose of ordering additional products. Once initiated, the data session can either be completed automatically by the print management components, or the data session can be turned over to a human operator for specification of exact products to be ordered.

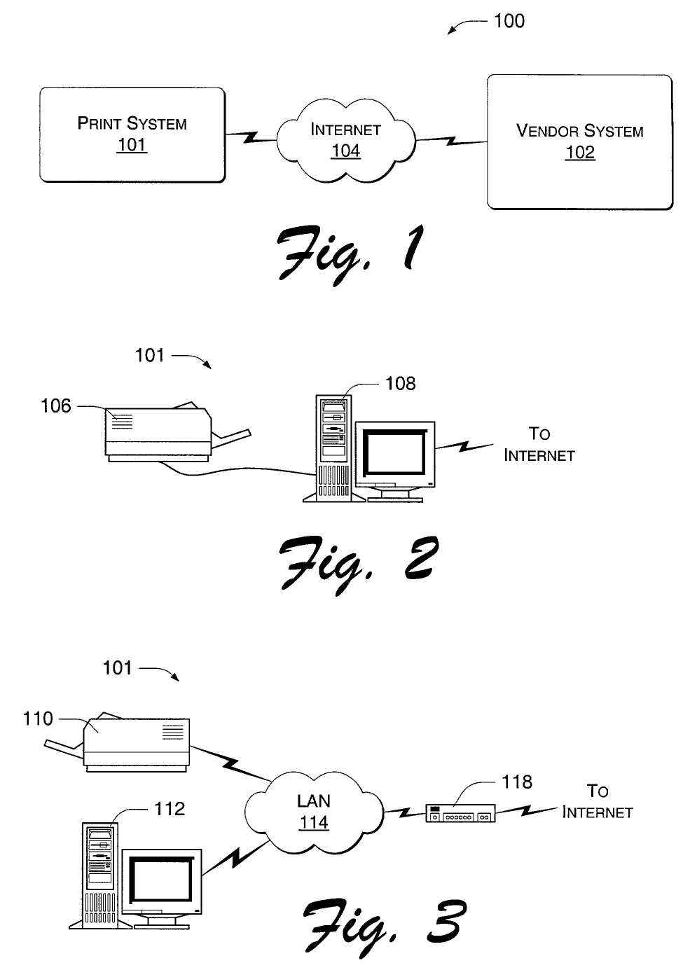

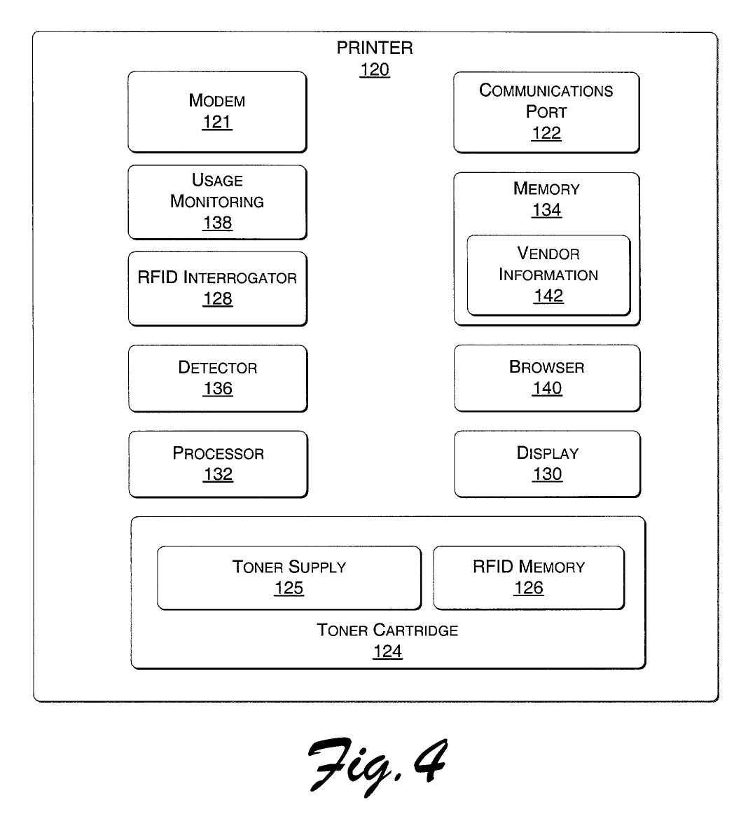

The functionality described above can be implemented within print system 101 in a variety of ways. FIGS. 2-5 illustrate examples of how such functionality might be implemented.

FIG. 2 shows an example of a customer print system 101, comprising a printer 106 and a host computer 108. In this example, the printer is connected for data communications with the computer through a printer port (not shown) of the computer. The computer, in turn, has a network interface adapter or modem (not shown) for communications with vendor system over a communications medium such as the Internet. Host computer 108 is equipped with Internet browsing software that functions as a user interface and as a tool for viewing and navigating hyperlinked Internet content. In addition, the host computer has printer-related software that is responsible for operating or at least managing printer 106.

FIG. 3 shows another embodiment of a print system 101, comprising a printer 110 and a computer 112. In this case, both printer 110 and computer 112 have network interface adapters (not shown) for direct connection to a local area network (LAN) 114. In most cases, computer 112 will have software-based printer interface components that manage printer 112 or at least supervise printing operations on printer 112. In addition, other computers (not shown) might also be configured to use printer 110 with similar printer support software.

In the example of FIG. 3, printer 110 and computer 112 have access to the Internet through a gateway 118. As in the case of FIG. 2, computer 112 is equipped with browsing software that allows viewing and navigating hyperlinked Internet content. Furthermore, printing device 110 can be equipped with its own Internet access software, allowing various functionality to be embedded within printing device 110. For example, with a minimal user interface printing device 110 can be configured to warn a printer operator of low toner levels, and to allow the printer operator to order supplies from an Internet-connected vendor.

Note that although the described configurations utilize the Internet for communications with a vendor system, other types of communications are also possible. For example, a print system 101 might be configured to initiate a dial-up connection directly to the vendor system 102, thus ensuring a higher degree of privacy regarding transferred information. Private networks might also be employed for communications between print system 101 and vendor system 102.

FIG. 4 shows exemplary components of a printer 120 such might typically be found in a customer print system. Printer 120 includes a network access component 121 and a communications port 122. The network access component 121 in this example is modem configured to access and communicate with vendor system 102 (FIG. 1), over the Internet or by way of a direct dial-up connection to the vendor system. Alternatively, the network access component might comprise a network interface card (NIC) configured to communicate over a local area network or wide area network, for eventual communications with the vendor system over the Internet.

Communications port 122 is a parallel port through which printer 120 communicates with a host computer, when operating in a configuration such as shown in FIG. 2. Other types of interface ports could alternatively be utilized.

Printer 120 includes a replaceable toner cartridge 124 that has a toner supply 125 stored therein. Although the present discussion will focus on the replacement of the toner cartridge 124, it is noted that the invention described herein is suitable for use related to any replaceable or replenishable component or material that is used in printer 120.

The toner cartridge 124 has radio frequency identification (RFID) memory 126 incorporated therewith. The printer is equipped with an RFID interrogator 128 through which the printer 120 can read from and write to the RFID memory 126 of the toner cartridge 124. The printer is configured to store various usage-related parameters on RFID memory 126. One purpose of the RFID is to allow a vendor to monitor and evaluate usage patterns based on information stored on the RFID. Typically, toner cartridges such as cartridge 124 are recyclable and are returned to the vendor at the end of their useful life. Prior to recycling the cartridges, the vendor can read the RFID information to obtain usage information relating to usage of printers and printer supplies by various customers. Common usage parameters might indicate such things as the number of pages printed with the toner cartridge and the different types or configurations of paper used when printing those pages. Time-related information might also be stored, such as the length of time the toner cartridge remained in use within the printer. In some cases, the RFID information might include information about the customer, such as name, address, etc.

Printer 120 further includes a display 130, a processor 132 and memory 134. A detector 136 is included that is configured to detect when a replaceable component in printer 120 is nearing or has reached the end of its functional life cycle. For purposes of the present discussion, the detector 136 is a low toner detector that detects when the toner supply 125 of the toner cartridge 124 has reached a depletion level indicating that a replacement toner cartridge (not shown) should be ordered to replace the toner cartridge 124. The detector 136 is shown located in the laser printer 120 itself, although the detector 136 may be integrated into the toner cartridge 124.

Printer 120 also includes a usage monitoring component 138 that is configured to monitor detector 136 to determine current toner supply levels in the toner cartridge 124. In one embodiment, usage monitoring component 138 is configured to automatically contact the vendor system 102 (FIG. 1) to initiate an order for a new toner cartridge when toner levels are low. Contact is made either directly using the modem 121 or by way of the Internet (not shown) using a browser 140. In some implementations, printer 120 will not include a browser. In these implementations, similar capabilities and procedures are implemented in conjunction with a browser that is implemented on a host computer associated with printer 120.

Supplies monitoring component 138 is also configured to respond to requests or queries regarding current toner supply levels or other usage parameters. Such queries might be received from an associated host computer or from a vendor system when contact is made with the vendor system for purposes of ordering new supplies. Requested information might include the number of pages printed since the last query, current toner levels, etc. In the described embodiment of FIG. 4, much of this information can be gathered from RFID memory 26. In other embodiments, such information might be simply stored in the printer's memory 134.

Supplies monitoring component 138 and browser 140 will in most cases be implemented primarily as software components, comprising instructions that reside in some form of computer-readable media such as memory 134 for execution by processor 132.

The memory 134 of the printer 120 also stores vendor information 142 that includes data about the vendor system 102 (FIG. 1), e.g., name, address, email address, remote access number, etc., for a vendor from which replaceable components may be ordered. The supplies monitoring component 138 uses the vendor information 142 to contact the vendor system and place an order for a printing device replaceable component.

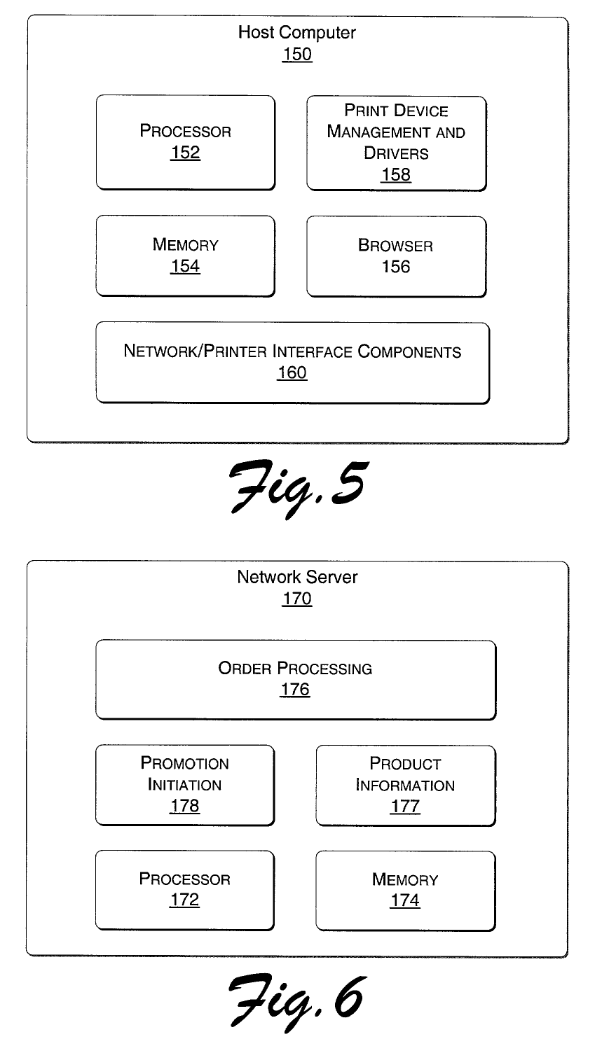

FIG. 5 shows exemplary components of a host computer 150 such as one of the host computers shown in FIGS. 2 or 3. The computer includes one or more processors 152 and one or more types of memory 154, potentially including both volatile primary memory and non-volatile secondary storage. The computer also includes a browser 156 and various printer-related software components that are represented in FIG. 5 as print device management and drivers 158. These software components are typically distributed on and reside in various types of computer-readable media, represented in this example by memory 154. For example, the software might be distributed on a removable media type such as a CD-ROM, loaded onto non-volatile secondary storage such as a hard disk, and then loaded into primary volatile memory for execution by processor 152.

Computer 150 also has network/printer interface components 160 that provide communications between one or more associated printers and potentially with a vendor system such as vendor system 102 shown in FIG. 1.

Print device management and drivers 158 include conventional printer drivers as well as printer management software. Such printer management software provides a user interface, allowing an operator to configure associated printers and to monitor operating parameters of such printers. For example, printer management software might allow a user to identify pending print jobs and/or to determine current toner levels. In addition, print device management software might be configured to monitor consumable products and to automatically warn an operator and/or initiate an ordering process when consumable levels are low, such as when a print cartridge's toner supply is low. Furthermore, print device management software can be configured to maintain usage parameters regarding associated printers, such as number of pages printed, types of print media, etc., similar to the types of information that are described above as being stored on RFID memory 126.

It should be recognized at this point that print system 101 of FIG. 1 can be instantiated in many different types of configurations, in addition to the two configurations shown in FIGS. 2 and 3. Furthermore, vendor system 102 is designed to accept orders from a plurality of such print systems.

Within each print system, responsibilities may be divided in different ways between different computer, printer, and network components. For example, the printer described above with reference to FIG. 4 includes components for monitoring usage parameters and for automatically initiating data sessions with vendor system 102 to order supplies when such supplies are low. However, these responsibilities could also be undertaken by a host computer such as that shown in FIG. 5. That is, print management software installed on a host computer might be configured to monitor various usage parameters and to also monitor levels of consumable or replenishable products within a printer, and to automatically initiate a data session with vendor system 102 to order such consumable or replenishable products. As a yet further alternative, such responsibilities might be shared between the printer and the host computer. Other types of components could conceivably also undertake these responsibilities.

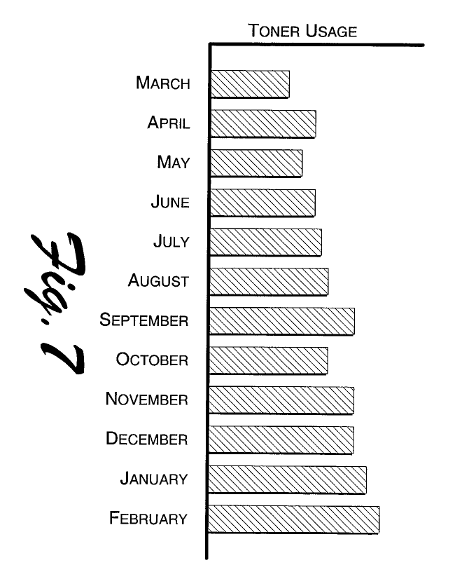

FIG. 6 shows pertinent components of a network server 170 that might comprise vendor system 102 (FIG. 1) in one embodiment. Except as described below, the network server is implemented using conventional hardware and software that have been developed for Internet commerce.

Network server 170 comprises one or more processors 172 and one or more types of memory 174, potentially including both volatile primary memory and non-volatile secondary storage. The computer also comprises conventional order processing components 176 that receive orders of print device consumable products for different print systems from network clients such as represented by print system 101 of FIG. 1. Order processing component 172 processes such orders in a conventional manner.

In addition, server 170 includes a product information component 177 and a promotion initiation component 178. These components cooperate, as will be described in more detail below, to enable targeted marketing of print device consumables to customers.

These software components described above, such as order processing component 176, product information component 177, and promotion initiation component 178, are typically distributed on and reside in various types of computer-readable media, represented in this example by memory 174. For example, the software might be distributed on a removable media type such as a CD-ROM, loaded onto non-volatile secondary storage such as a hard disk, and then loaded into primary volatile memory for execution by processor 172. Alternatively, portions of the software might be distributed by a printer vendor over a network such as the Internet, and received by customer equipment either automatically or at the specific request of the customer.

Methodological Operations

Print system 101 (FIG. 1) includes components such as already described that monitor print operations and that initiate data sessions with vendor system 102 to order replacements for consumable products. Such data sessions can be initiated automatically in response to decreased levels of such consumable products, either by a computer associated with a printer or by the printer itself. Alternatively, an operator might manually initiate the ordering process. Completion of the ordering process may or may not require operator interaction.

Preferably, a data session involves one or more components that are closely associated with the printer, either by virtue of being implemented within the printer itself or by virtue of being designed specifically to support the printer (for example, print drivers and print management software running on a host computer). The involvement of such components allows the ordering process to be streamlined by automatically providing certain information to vendor system 102. For example, in an implementation such as FIG. 2 where communications with a vendor system is through a host computer 108, the data sessions are preferably established in conjunction with print management software running on the host computer. The print management software specifies information to the vendor system such as printer model and make. Additionally, the print management software might be configured to automatically provide additional information, such as identifying information regarding the owner or operator of the printer. Alternatively, in an implementation such as shown in FIG. 3 where a printer 110 might communicate directly with vendor system 102, the printer itself is configured to provide information such as printer model and make. This reduces the amount of information that is required to be provided by a user.

Shifting attention now to FIG. 6, order processing component 176 of network server 170 is configured to establish data sessions with requesting print systems, and during the data sessions to receive orders of print device consumable products for such print systems. During the data sessions, order processing component 176 obtains needed information regarding orders of consumable products. Some of this information is provided automatically, such as identification of a particular product (toner cartridge) that is needed for the subject printer. In some cases, the operator might have to enter additional information, such as quantities desired, billing information, shipping information, etc.

In addition to the information mentioned above, product information component 177 of network server 170 is configured to operate in conjunction with the order processing component to receive usage parameters from print components associated with the print system. Such print components might comprise the printer itself, components within the printer (such as an RFID memory associated with a consumable product like a toner cartridge), a host computer associated with the printer, and/or software components within such a host computer that are designed to operate in conjunction with the printer (such as print drivers, management software, etc.). The usage parameters relate to levels of print device consumable products or to quantities of such products used during given time frames. For example, the usage parameters might indicate current remaining levels of print system toners, numbers of pages printed since a certain time or since the last order, numbers of toner cartridges or other replaceable components used since a certain time or since the last order, types of paper used in the printing process, etc. Generally, the parameters are designed to indicate levels of usage of consumable products such as toner, ink, or paper.

In addition to the usage parameters, it may be desirable for the product information component 177 to obtain information about the customer itself. For example, if the customer is a business, it might be desirable to obtain information relating to the size of the business, the type of business, and other information that might be used for marketing purposes. Incentives might be offered in order to encourage the customer to provide such personal or business related information.

Product information component 177 is configured to accumulate these parameters over time, for individual printers or print systems that regularly establish data sessions with vendor system 102. In the case where a particular print system includes a plurality of printers, the parameters may be accumulated for these printers as a group, rather than individually.

Promotion initiation component 178 of network server 170 is configured to calculate and monitor consumable product usage by the print systems or print devices over time, as a function of the usage parameters received in data sessions that occur periodically when the customer orders replacements for consumable products. In the described embodiment, for example, promotion initiation component 178 monitors toner usage over time for individual printers or print systems.

The promotion initiation component is further configured to calculate and detect changes in consumable usage by particular print systems and/or print devices of the print systems. For example, the promotion initiation component can examine usage parameters over time to calculate quantities of toner used within given time periods, such as the amount of toner or the number of toner cartridges used each month. In response to such calculations, the promotion initiation component can detect changes in the most recent month, as compared with previous months.

The promotion initiation component is further configured to initiate promotional actions, directed to operators of particular print systems, in response to detected or calculated changes in consumable product usage by said particular print systems. Such promotional actions might comprise a variety of things, such as simply notifying the customer or presenting or proposing alternative purchase contracts for consumable products. Promotional proposals such as this might be presented during the normal ordering process, as email descriptions of purchase options, or even by personal contact from a representative or salesperson of the vendor.

More specifically, promotion initiation component 178 is configured to initiate promotional actions only if consumable product usage changes by a predetermined amount or percentage, such as 20% for example. Calculating usage changes can be based on any given time period, such as time periods between orders or arbitrary units of time such as weeks or months.

Promotional actions in many cases will include proposing an enhanced or improved purchase plan or contract. For example, increased usages might qualify the customer for quantity discounts that would not previously have been available. In this case, the promotional actions comprise offering such quantity discounts to the customer. In many cases, this alone will serve to enhance customer loyalty to the vendor. Furthermore, offers of promotional discounts might be made contingent on the customer committing contractually to future purchases from the vendor.

Decreases in consumption of consumable products will also be used to generate promotional actions. In cases where consumption of consumable products has decreased, such promotional actions might include offering special incentives such as rebates or one-time discounts in order to entice customers back to the vendor's products.

Communication of these offers to the customer preferably takes place during the automatic ordering procedure between print system 101 and vendor system 102. Often, this procedure will involve graphical presentations implemented using Internet browsing technology. Promotional offers can be incorporated into such presentations. Alternatively, the vendor might take the opportunity to make person-to-person contact with the customer in order to ensure the highest possible degree of customer satisfaction. The decision of whether to initiate a person-to-person contact might be made based on the amount by which the customer's usage has changed. Mail and email are yet other alternatives for communicating promotional offers.

If the promotional actions are completed as an integral part of the automated order processing procedure, no human interaction will be required of the vendor. In other cases, the promotion initiation component 178 might simply notify vendor salespersons of customers whose usages have increased or decreased. Such notification might take the form of automatically generated email to the vendor salespersons or lists of customers that are communicated to salespersons. The salespersons or other vendor representatives can then contact the customers using any means that are felt to be most effective.

Privacy might be a concern to many customers. Accordingly, provision is made to obtain the customer's consent before gathering and storing usage parameters regarding the customers' print systems. An incentive for obtaining such consent might be to periodically compose graphical usage charts and to send such charts by mail or email to the operators of the print systems. An example of such a chart is shown in FIG. 7, showing toner usage over a preceding one year period. Such charts might indicate toner consumption, printed page counts, or other parameters as a function of time.

Conclusion

The techniques described above allow marketing and promotional activities to be initiated at times when customers might be most receptive to such activities. Specifically, the techniques allow a vender to point out usage changes to a customer, thereby alerting the customer that decisions need to be made regarding purchase options. By both alerting a customer to this fact and at the same time offering enhanced pricing structures or other promotions, a vendor is able to maximize its promotional efforts.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A method, comprising:
establishing data sessions to receive orders of print device consumable products for one or more print systems;
during the data sessions, obtaining usage parameters relating to print device components associated with the different print systems;
calculating consumable product usage by the print systems over time as a function of the usage parameters obtained during a plurality of the data sessions; and
initiating promotional actions directed to operators of particular print systems in response to changes in consumable product usage by said particular print systems.

2. A method as recited in claim 1, wherein the usage parameters comprise parameters indicating levels of print device consumable products.

3. A method as recited in claim 1, wherein the usage parameters comprise parameters indicating current remaining levels of print system toner.

4. A method as recited in claim 1, wherein the usage parameters comprise parameters indicating numbers of pages printed.

5. A method as recited in claim 1, wherein said initiating is performed only if consumable product usage changes by a predetermined amount.

6. A method as recited in claim 1, wherein said initiating is performed only if consumable product usage changes by a predetermined percentage.

7. A method as recited in claim 1, wherein the promotional actions comprise:
composing graphical usage charts based on the usage parameters;
sending the graphical usage charts to the operators of said particular print systems.

8. A method as recited in claim 1, wherein the promotional actions comprise:
composing graphical usage charts based on the usage parameters, the graphical usage charts indicating printed page counts over sequential time periods; and
sending the graphical usage charts to the operators of said particular print systems.

9. A method as recited in claim 1, wherein the promotional actions comprise contacting the operators to propose alternative purchase contracts for consumable products.

10. A method as recited in claim 1, wherein the promotional actions comprise notifying the operators of changes in their usage of the consumable product.

11. A method as recited in claim 1, wherein obtaining usage parameters comprises obtaining said usage parameters from memory that is associated with the consumable products.

12. A method as recited in claim 1, wherein obtaining usage parameters comprises obtaining said usage parameters from memory that is incorporated with the consumable products.

13. A network server comprising:
an order processing component that receives orders of print device consumable products for different print systems from network clients;
a product information component that operates in conjunction with the order processing component to receive usage parameters from print components associated with the different print systems;
a promotion initiation component that monitors consumable product usage by the print devices over time as a function of the received usage parameters; and
wherein the promotion initiation component initiates promotional actions directed to operators of particular print systems in response to changes in consumable usage by said particular print systems.

14. A network server as recited in claim 13, wherein the usage parameters comprise parameters indicating levels of print device consumable products.

15. A network server as recited in claim 13, wherein the usage parameters comprise parameters indicating current remaining levels of print system toner.

16. A network server as recited in claim 13, wherein the usage parameters comprise parameters indicating numbers of pages printed.

17. A network server as recited in claim 13, wherein the promotion initiation component initiates the promotional actions only if consumable product usage changes by a predetermined amount.

18. A network server as recited in claim 13, wherein the promotion initiation component initiates the promotional actions only if consumable product usage changes by a predetermined percentage.

19. A network server as recited in claim 13, wherein the promotional actions comprise:
composing graphical usage charts based on the usage parameters;
sending the graphical usage charts to the operators of said particular print systems.

20. A network server as recited in claim 13, wherein the promotional actions comprise:
composing graphical usage charts based on the usage parameters, the graphical usage charts indicating printed page counts over sequential time periods; and
sending the graphical usage charts to the operators of said particular print systems.

21. A network server as recited in claim 13, wherein the promotional actions comprise contacting the operators to propose alternative purchase contracts for consumable products.

22. A network server as recited in claim 13, wherein the promotional actions comprise notifying the operators of changes in their usage of the consumable product.

23. A network server as recited in claim 13, wherein obtaining usage parameters comprises obtaining said usage parameters from memory that is associated with the consumable products.

24. A network server as recited in claim 13, wherein obtaining usage parameters comprises obtaining said usage parameters from memory that is incorporated with the consumable products.

25. One or more computer-readable media containing computer-executable instructions are executable to perform actions comprising:
establishing data sessions to receive orders of print device consumable products for one or more print systems;
during the data sessions, obtaining usage parameters relating to print device components associated with the different print systems;
calculating consumable product usage by the print systems over time as a function of the usage parameters obtained during a plurality of the data sessions; and
determining whether consumable product usage in a particular print system has changed by a predetermined amount; and
if consumable product usage in the particular print system has changed by the predetermined amount, initiating promotional actions directed to an operator of said particular print system.

26. One or more computer-readable media as recited in claim 25, wherein the usage parameters comprise parameters indicating levels of print device consumable products.

27. One or more computer-readable media as recited in claim 25, wherein the usage parameters comprise parameters indicating current remaining levels of print system toner.

28. One or more computer-readable media as recited in claim 25, wherein the usage parameters comprise parameters indicating numbers of pages printed.

29. One or more computer-readable media as recited in claim 25, wherein said predetermined amount comprises a predetermined percentage of previous usage.

30. One or more computer-readable media as recited in claim 25, wherein the promotional actions comprise:
composing graphical usage charts based on the usage parameters;
sending the graphical usage charts to the operators of said particular print systems.

31. One or more computer-readable media as recited in claim 25, wherein the promotional actions comprise:
composing graphical usage charts based on the usage parameters, the graphical usage charts indicating printed page counts over sequential time periods; and
sending the graphical usage charts to the operators of said particular print systems.

32. One or more computer-readable media as recited in claim 25, wherein the promotional actions comprise contacting the operators to propose alternative purchase contracts for consumable products.

33. One or more computer-readable media as recited in claim 25, wherein the promotional actions comprise notifying the operators of changes in their usage of the consumable product.

34. One or more computer-readable media as recited in claim 25, wherein obtaining usage parameters comprises obtaining said usage parameters from memory that is associated with the consumable products.

35. One or more computer-readable media as recited in claim 25, wherein obtaining usages parameters comprises obtaining said usage parameters from memory that is incorporated with the consumable products.
